(19) United States
(12) Patent Application Publication
(10) Pub. No.: US 2010/0040903 A1
(43) Pub. Date: Feb. 18, 2010

(54) Anisotropically compliant horns for ultrasonic vibratory solid-state bonding

(75) Inventors: Andrew S. Kalt, Palo Alto, CA (US); Marvin Keshner, Sonora, CA (US); Donald Winston Rice, San Jose, CA (US); Frederick A. Stawitcke, Sunnyvale, CA (US); Jessie Ramirez Sanchez, San Jose, CA (US)

Correspondence Address: ELIZABETH ANNE NEVIS, 1219 TORRANCE AVE., SUNNYVALE, CA, 94089, US

(73) Assignee: OPTISOLAR, INC., A DELAWARE CORPORATION, Hayward, CA (US)

(21) Appl. No.: 12/192,075

(22) Filed: Aug. 14, 2008

(51) Int. Cl. B32B 15/01; B23K 20/10

(52) U.S. Cl. 428/615; 228/1.1; 228/110.1

(57) ABSTRACT

A horn for vibratory solid-state ultrasonic welding of metals and similarly-behaved materials “self-levels” to produce wide continuous seams or large-area spot-welds between delicate workpieces without damage, even if the workpieces are not perfectly flat and parallel to the nominal toolface angle. The horn toolface flexes under pressure to conform to skew-angled workpieces because it is disposed on a tool head supported by a tool neck cut from the tool body. The tool head, the tool neck, or both are anisotropically compliant. When resonances are properly optimized for typical VSS modes of vibration, atypical but useful localized modes are excited at the compliant toolface edges, actually intensifying the bond energy where one might normally expect unwanted damping. Various design approaches optimize the characteristics of the tool head and tool neck to various materials and bonding configurations. The horns can be configured for use with existing ultrasonic welders.

### RELATED APPLICATIONS

None

### FEDERALLY SPONSORED RESEARCH AND DEVELOPMENT

None

### APPENDICES

None

### BACKGROUND OF THE INVENTION

This invention relates generally to vibratory solid-state (VSS) bonding, a type of ultrasonic welding (USW) used to join metals and similarly-behaved materials. In particular, this invention relates to ultrasonic welding of foils to coated substrates. One potential application is attaching leads or conductive members to semiconductor devices.

The following terms will have the following definitions in this document:

Bond interface: the overlap region between two surfaces to be bonded.

Crowned (toolface): having a convex radius worked on the surface contacting the workpiece to reduce the angle-sensitivity of the concentration of bonding energy and the width of the resulting bond.

Foil: includes metal foils and any other type of initially unattached thin films, tapes, webs, meshes, and flexible sheets made of any material. This usage is common in European English and is adopted here to avoid confusion with the thin “films,” already deposited on the substrate, to which the foils are bonded.

Horn: the part of an ultrasonic welding apparatus that transfers ultrasonic vibration to the workpieces, sometimes called “sonotrode” or “hone.”

Horn stem: the part of a horn directly connected to the source of ultrasonic vibration.

Piston mode: a mode of vibration along a line parallel to the rotation axis of a rotary horn or perpendicular to the toolface of a spot-welding horn.

Rotary horn: a horn with a toolface disposed around its perimeter, in the form of a cylinder, cone, cam, or other geometry suitable for rotating as it travels over the workpiece. A rotary horn can bond a continuous seam by rotating its tool body around its horn stem, taking the toolface with it, as the workpieces are advanced beneath it.

Spot-welding horn: a horn with a substantially planar toolface disposed on an end of its tool body. Typically, a spot-welding horn must be lifted from the workpieces in order to move from one bonding target area to another.

Thermoplastic USW: an ultrasonic welding process in which workpiece surfaces melt at the bond interface. The bond is formed when the materials fuse as they cool. This bonding method is commonly used for bonding thermoplastic materials.

Tool body: the solid part of the horn supporting the toolface in prior-art horns, and supporting the tool neck in embodiments of this invention.

Toolface: the surface of the horn that contacts the workpieces.

Tool head: a section of a horn supporting a toolface and supported by a tool neck. The tool head may be designed to flex under pressure to conform to workpiece surfaces that are not ideally aligned to the toolface's nominal orientation.

Tool neck: a connecting member or members between a horn's tool head and its tool body. The tool neck may be designed to flex under pressure to allow the tool head to align to workpiece surfaces that are not ideally aligned to the toolface's nominal orientation.

Torsional mode: an arcuate mode of vibration around the rotation axis of a rotary horn or parallel to the toolface of a spot-welding horn.

Vibratory solid-state ultrasonic welding (VSS USW): an ultrasonic welding process in which workpiece surfaces structurally soften to a plastic state at the bond interface and come into intimate contact, but do not melt. The bond is formed by atomic attraction or mechanical interlocking when the ultrasonic excitation ceases. This bonding method is commonly used to bond metals and similarly-behaved materials.

Both thermoplastic and VSS bonding are commonly termed “ultrasonic welding.” While both processes involve the combination of pressure with ultrasonic vibration to form a bond, their physics are fundamentally dissimilar. Thermoplastic USW depends on localized melting of the workpiece surfaces at the bond interface, and the optimum mode of ultrasonic vibration is usually substantially perpendicular to the bond interface. VSS USW, by contrast, forms bonds between metals and similarly-behaved materials at temperatures far below their melting points. Bonding depends on a combination of localized structural softening of the workpiece surfaces and intimate contact between them. Although Joshi notes that VSS bonding can be achieved by ultrasonic vibrations in any direction, a vibration direction substantially parallel to the bond interface is preferred by most industries. The advantage of using either a linear or torsional mode of vibration substantially parallel to the bond interface is that these vibrational modes are efficient at removing surface impurities from the bonding surfaces, by “scrubbing” the workpieces back and forth against each other, before forming the bond. This desirable side effect can eliminate extra cleaning steps before bonding and obviate special pre-bonding storage conditions, reducing production costs. Because of the critical differences between thermoplastic and VSS USW in both tool mechanics and bonding physics, solutions designed for thermoplastic USW are not necessarily effective for VSS USW, even if some of the problems may seem similar.

FIG. 1 is a conceptual diagram of a generic prior-art VSS spot-welder. Systems like this are available commercially from vendors such as Amtech Ultrasonic. Pressure and vibration source 100 produces pressure in direction 103 and ultrasonic vibrations back and forth in direction 102 or some other substantially horizontal direction (if this were a thermoplastic process, the vibration would be vertical). The ultrasonic vibrations typically have 5-20 micron amplitude with 10-50 kHz frequency. Horn 104 is coupled to vibration and pressure source 100 by horn mount 101. Horn 104 transmits the pressure and vibration from source 100 to workpieces 105 and 106, which overlap under horn 104 at bond interface 108. The parts of horn 104 are horn stem 104a, tool body 104b, and toolface 104c which contacts the top workpiece 105, a foil. Anvil 107 supports the bottom workpiece 106, a substrate. Horn 104 presses foil 105 against substrate 106 and vibrates in direction 102 (or some other substantially horizontal direction, possibly including a torsional mode around the horn stem axis). First, the ultrasonic vibration “scrubs” workpieces 105 and 106 against each other, removing impurity layers from the workpiece surfaces and pushing them outside bond-interface area 108. The ultrasonic vibration also structurally softens the workpiece surfaces at the bond interface; these surfaces plastically deform until intimate contact is achieved. When the ultrasonic vibration stops, atomic or crystalline forces take over to solidify and fuse the surfaces in a true metallurgical bond.

Some applications require long, continuous seams. The basic spot-welding apparatus of FIG. 1 can only produce these seams one small section at a time. To speed the process and maintain uniformity along the seam, rotary horns were developed.

FIG. 2 is a perspective view of a system for rotary ultrasonic welding. Anvil 207 supports substrate 206. Foil 205 is placed on substrate 206 at the desired bonding location. Pressure and vibration source (not shown) produces pressure in direction 203 and ultrasonic vibration in lateral direction 202a (or in torsional direction (202b)). However, rotary horn 204's tool body 204b is disk-shaped (or sometimes cam-shaped for making intermittent or otherwise non-uniform seams). Horn toolface 204c is on the outer curved surface of tool body 204b. Horn stem 204a extends along toolface 204c's center of rotation and is held by horn mount 201. Some rotary horns also have a second horn stem (204d) extending from the opposite side of tool body 204b and held by a second horn mount (211). To bond a continuous seam, rotary horn 204 rotates around its horn stem in direction 209 to engage successive regions of its toolface 204c with successive regions of the workpieces 205 and 206. An alternate arrangement, sometimes used when both foil 205 and substrate 207 are long, flexible sheets or ribbons, is to use both a rotary horn and a counter-rotating rotary anvil, as in Onishi's U.S. Pat. No. 4,333,791.

Resonance optimization at the intended ultrasonic bond frequency is critical to the efficiency of rotary horns, because the entire horn is a resonator (and parts of it can become separate resonators). Spot-welding horns are sometimes less sensitive to resonance issues because of their smaller size relative to the actuator and horn mount, and their simpler shape; typically they behave more like incidental tool tips than like resonators, though care must still be taken to optimize resonance characteristics.

VSS USW has become a popular method for connecting electrical leads and contacts to electronic components and assemblies because (1) it requires no extra materials such as solder or flux; (2) cleaning of the bonding surfaces can be integrated with bonding with no extra tools or materials, as described above; (3) it can be designed to produce very little heat, minimizing the risk of damage to thermally-sensitive components, and (4) the resulting bonds are mechanically strong and often as electrically conductive as the bulk workpiece materials

Many electronic assemblies, such as printed circuit boards, have conductive contacts in the form of thin films on substrates. The leads from these contacts can be wires or conductive foils. Metals, such as aluminum or copper, are preferred for both contacts and leads because of their high conductivity, mechanical strength, ready availability, and low cost.

Electrical components can be damaged by excessive current. Current-carrying capacity can be increased by either (1) increasing the conductivity of the current-carrying material, or (2) increasing the cross-sectional area of the current-carrying path. When a current-carrying connection is made between thin conductors such as foils and films, the connected surface area must be large enough to carry the expected level of current with low impedance. High impedance can cause electrical inefficiency, undesirable heating of the surrounding electronics that degrades their performance, or damage to the connection and surrounding areas.

The mechanical strength of a bond between thin members such as foils and films is also proportional to the bonded area. Mechanical strength enables a bond to survive a variety of shipping and storage conditions, as well as a long lifetime of use. Another factor in the mechanical durability of a bond is the securing of edges, ends, or corners to prevent snagging and exclude foreign material and reduce step height for better coverage by any successively deposited layers.

Some applications, such as the conductive leads for solar cells described by Karg et al. in PCT Int'l Pub. No. WO2003/012883, and commutator connections for large motors described by Schwertdle & Altpeter in U.S. Pat. No. 6,213,377, are highly demanding of both conductivity and mechanical strength. Different applications and designs may require increasing the area of a thin-film bond by increasing its length, width, or both. The prior art in ultrasonic welding is limited in the area of the weld it can reliably produce between a thin-film-coated substrate and a foil or multi-wire conductor in a single pass without damaging the thin film or any underlying structures on the substrate. This is because, although the compression and ultrasonic vibration work together to create the bond, they also oppose each other in one aspect: The compression increases friction between the workpieces at the bond interface, and the ultrasonic vibration must overcome that friction to initiate and sustain the “scrubbing” motion that removes surface impurities.

A threshold pressure (force per unit area), which depends on characteristics of workpieces and on the amplitude and frequency of the ultrasonic vibration, is required to sufficiently stress both workpieces to enable the vibration to soften the bond interface to a plastic state. Applying the same minimum pressure to a larger bond-interface area increases the total force normal to the bond interface, which increases friction between the workpieces. The ultrasonic vibration must overcome this friction to initiate the “scrubbing” action that removes surface impurities at the bond interface. However, a delicate workpiece (such as a thin film) is easily damaged by excessive ultrasonic vibration. Therefore, prior-art VSS horns designed for delicate workpieces are usually configured for small-area bonds, ensuring that the threshold-pressure friction at the bond interface can be overcome by low-energy ultrasonic vibrations that cannot damage the workpieces. As a result, large-area bonds of foils to thin films (that is, bonds that are both wide and long) generally require multiple passes with a small-area toolface, which increases processing time, processing complexity, and production cost.

Even if the average pressure/vibration combination over the bond interface is below the workpiece damage threshold, an excessive localized concentration of pressure and vibration can still damage delicate workpieces. Unwanted localized concentrations can occur under a sharp edge or corner of a toolface that engages the workpieces at a skewed angle. Skewed engagement angles result from ordinary workpiece tolerances in flatness and parallelism.

FIG. 3a shows the effect of a horn 304 engaging the workpieces at a skewed angle, in this case because substrate 306 is wedge-shaped. The angle in the drawing is exaggerated for clarity. Horn 304 applies a pressure greater than the threshold pressure Pth, but well below the damage-threshold pressure P_{d}, at the center of the toolface. The intended pressure distribution is shown by line 309 on graph 331, corresponding to a damage-free bond the same width as the toolface. However, the skewed engagement angle causes the actual pressure distribution to resemble line 339 on graph 331: the edge of the toolface nearest the horn stem does not engage the workpieces at all, and the edge of the toolface farthest from the horn stem bites into foil 305 with a localized pressure greater than damage threshold P_{d}. The actual bond begins only where line 339 rises above Pth, so it is narrower than intended. If the peak pressure under the toolface edge is high enough, the ultrasonic vibration creates a structural disruption 334 centered under the sharp edge of the toolface. Thin films on the top surface of substrate 306 are particularly vulnerable to damage from these structural disruptions. Micrography of this type of damage shows that films coated on substrates often damage well before foils. In addition, films below the top layer may incur damage before the top layer if their damage thresholds are lower. Very large peak-energy concentrations under sharp toolface edges can also cause a curled-up edge 333 or a tear 332 in the foil, or move the foil out of position (in the direction of less constraint).

One prior-art approach to preventing sharp-edge damage to delicate or incompressible workpieces that may not be perfectly flat or parallel is to “crown” the toolface, making it slightly toroidal so that no sharp edges or corners contact workpieces. FIG. 3b shows a crowned rotary horn 304k engaging the non-ideal workpieces of FIG. 3a. The intended pressure distribution is shown by line 309k on graph 341, but the skewed engagement angle causes an actual pressure distribution that resembles line 349k instead. Comparing FIGS. 3a and 3b, the crowned shape produces much less displacement of the spatial center of the bond and much less risk of a localized pressure that exceeds damage threshold P_{d} on skewed workpieces. Both rotary horns and spot-welding horns can be made with crowned toolfaces. Sometimes only the horn is crowned, as in Japanese Patent No. 2004-114136 to Miura, but when the substrate is flexible or compressible, the anvil may be crowned as well, as in published U.S. Pat. App. No. 2006/0169388 to Shimizu & Matsuyama.

Crowned rotary horns are popular for ultrasonic bonding of delicate workpieces such as foils and thin-film coatings, because they cost much less than either requiring very tight workpiece tolerances or adding metrologically-controlled angle adjustments to the VSS tool. The drawback, as pressure-distribution lines 309 and 309k in FIGS. 3a and 3b show, is that the bond produced by crowned horn 304k will be significantly narrower than that produced by uncrowned horn 304 under ideal conditions when the workpieces are flat and parallel. A typical effective bond interface for a crowned horn is only about 1-2 mm wide, and its angle tolerance is only approximately ±1°. Both larger bond widths and larger angle tolerances would be highly advantageous in some applications involving delicate workpieces.

Another prior-art approach to preventing sharp-edge damage to delicate or incompressible workpieces that may not be perfectly flat or parallel is to place an extra protective member between the horn and workpiece. For example, in U.S. Pat. No. 5,785,786 to Suzuki et al., a protective member prevents trace marks in the top workpiece. This method seems to work well when the top workpiece (or its top layer) is the easiest to damage. However, while the protective member may more evenly distribute some of the force from sharp toolface edges, the ultrasonic amplitude must be increased to counteract damping introduced by the protective member. Under certain conditions this increased ultrasonic amplitude could be transmitted to any buried layers underneath the top workpiece, causing damage if the buried layers are delicate. Furthermore, the protective member may in some cases adhere to the horn or to the top workpiece; in Japanese Patent No. 2004-114136, the protective layer is intentionally bonded to the substrate along with the foil it protects.

Yet another prior-art approach to preventing sharp-edge damage to delicate or incompressible workpieces that may not be perfectly flat or parallel is to add a layer of compliant material to the horn or anvil. In U.S. Pat. No. 4,461,662, Onishi creates a flexible anvil surface for thermoplastic USW of textile seams by layering foam rubber and silicone over the solid anvil. This is a prime example of a solution that is effective for thermoplastic USW, but not very effective for VSS USW: the '662 anvil's compliant layers (or those of a similarly built horn to use with a solid anvil) would damp the vibrations too much for VSS USW, and prolonged vibration in the typical VSS direction would create shear stresses between the layers of different materials, quickly delaminating them. Therefore, any solution for VSS USW must maintain stiffness in the direction of the ultrasonic vibration.

Therefore, a need exists for a way to form large-area damage-free VSS bonds between delicate workpieces, such as foils and thin films, in a variety of aspect ratios with decreased sensitivity to workpiece flatness and parallelism tolerances.

### BRIEF SUMMARY OF THE INVENTION

An object of this invention is to desensitize VSS USW of foils and thin-film coatings to ordinary workpiece tolerances in thickness, flatness, and parallelism. Accordingly, the invention includes a horn with a tool head and tool neck. The tool head, the tool neck, or both are compliant to enable the toolface to self-correct its engagement angle as it bonds. This horn is particularly designed to minimize both damping and compliance losses of ultrasonic vibrations in the typical bond-interface-parallel VSS modes because its compliance is anisotropic. The horn is stiff in the direction of ultrasonic vibration and compliant in the direction perpendicular to the bond interface.

Another object of this invention is large-area, damage-free VSS bonds between delicate workpieces such as foils and thin-film coatings. Accordingly, the anisotropically compliant horns included in this invention do not concentrate excessive energy at sharp edges or corners in a way that creates disruptions in the workpieces, so they need not be crowned (crowning tends to decrease bond-interface area).

Another object of this invention is to add the capability to make large-area, damage-free bonds of delicate workpieces at low cost. Accordingly, the anisotropically compliant horns of this invention may be made compatible with existing VSS USW tools without further modifying the expensive anvils, horn mounts, or pressure/vibration sources.

### BRIEF DESCRIPTION OF THE DRAWINGS

FIG. 1 is a side-view conceptual diagram of a generic prior-art VSS spot-welder.

FIG. 2 is a perspective-view conceptual diagram of a prior-art VSS rotary welder.

FIG. 3a is a prior-art rotary horn engaging workpieces at a skewed angle, with a diagram of pressure distribution across the workpieces.

FIG. 3b is a prior-art crowned rotary horn engaging workpieces at a skewed angle, with a diagram of pressure distribution across the workpieces.

FIG. 4 is an anisotropically compliant rotary horn according to a preferred embodiment of the invention.

FIG. 5a is a partial side view of an anisotropically compliant rotary horn engaging workpieces at a skewed angle, with a diagram of pressure distribution across the workpieces.

FIG. 5b is a perspective view of the pressure-induced deformation of a relatively compliant tool head on a preferred-embodiment anisotropically compliant rotary horn.

FIG. 5c is a perspective view of the pressure-induced deformation of a relatively compliant tool neck on an alternate-embodiment anisotropically compliant rotary horn.

FIG. 6 is an exaggerated view of extrema of a piston-mode resonance in a prior-art rotary horn.

FIG. 7 is an exaggerated view of extrema of a piston-mode resonance in a preferred-embodiment rotary horn.

FIG. 8 shows top and side views of an exaggerated extremum of a ribbon-mode resonance in a preferred-embodiment rotary horn.

FIG. 9 is a spot-welding horn with an anisotropically compliant toolface according to a preferred embodiment of the invention.

FIG. 10 shows an alternate embodiment of a rotary horn with a flexible tool neck and a relatively rigid tool head.

FIG. 11 shows an alternate embodiment of a rotary horn with a multi-component tool neck.

FIG. 12 shows an alternate embodiment of a spot-welding horn with a multi-component tool neck.

FIG. 13 shows an alternate embodiment including a toolface with a concave radius.

FIG. 14 shows an alternate embodiment including a concave faceted toolface.

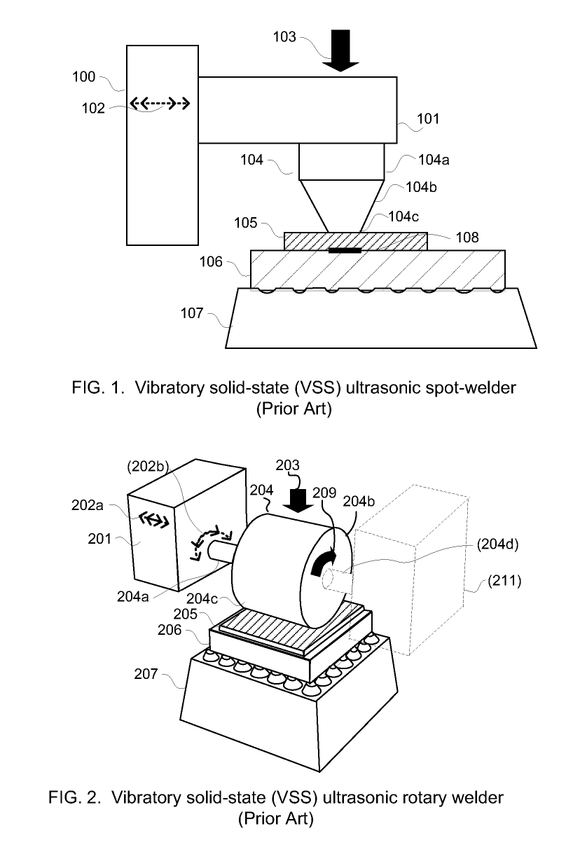

### DETAILED DESCRIPTION OF THE INVENTION

The self-leveling ultrasonic horns of this invention have built-in anisotropically compliant members allowing their toolfaces to flex when pressed down onto a workpiece until the toolface conforms to the workpiece surface. Thus, even if one of the invented horns engages workpieces at a skewed angle, the entire width of the toolface contacts the workpiece and forms a bond of the full intended width, and the bonding energy is equalized across the bond area so that no localized damage zones are created.

Commercial ultrasonic actuators can supply ultrasonic wave amplitudes far in excess of what is needed to form a strong, damage-free VSS bond between a foil and a thin-film-coated substrate. Therefore, maximum efficiency is not a major concern and some damping can be tolerated. However, because the compliance of the invented toolfaces is anisotropic, stiffness is maintained in the direction of vibration, minimizing damping in all embodiments and potential delamination of multiple-layer embodiments.

FIG. 4 shows a perspective view of a preferred-embodiment anisotropically compliant rotary horn, and a cross-section taken through the line 4-4. Horn 404 is fabricated from a single piece. When operating, it rotates around horn-stem axis A. Cutouts 404d in tool body 404b leave only enough material for a tool neck 404e. Whether tool neck 404e is a single connecting member (as shown here) or multiple connecting members (as shown in some later figures), it mechanically connects the tool head 404f, on which the toolface 404c is disposed, with the main tool body 404b that extends from the horn stem 404a. In this embodiment, tool neck 404e is located substantially behind the center of toolface 404c (here, at the equator of the cylindrical toolface).

The compliance anisotropy of the horn is diagrammed in FIG. 4 as follows: Toolface 404c is stiff along direction 420, parallel to axis A (the direction of a linear vibration mode useful for VSS USW). Toolface 404c is also stiff along direction 421, the angular direction around axis A (the direction of a torsional vibration mode useful for VSS USW). The compliance allows the toolface to flex to angles such as 422 and 423 to correct for skewed workpiece engagement angles. The optimal thickness of tool neck 404e and tool head 404f depend on the hardness of the horn material and the range of workpiece engagement angles to be tolerated by the tool. Horn stem 404a can be configured to fit the horn mount of an existing VSS tool. Those skilled in the art will recognize that the rotary horn of FIG. 4, and similar alternate embodiments, can be made with dual horn stems, or with a cam-shaped tool body for bonding non-continuous seams, without exceeding the scope of this invention.

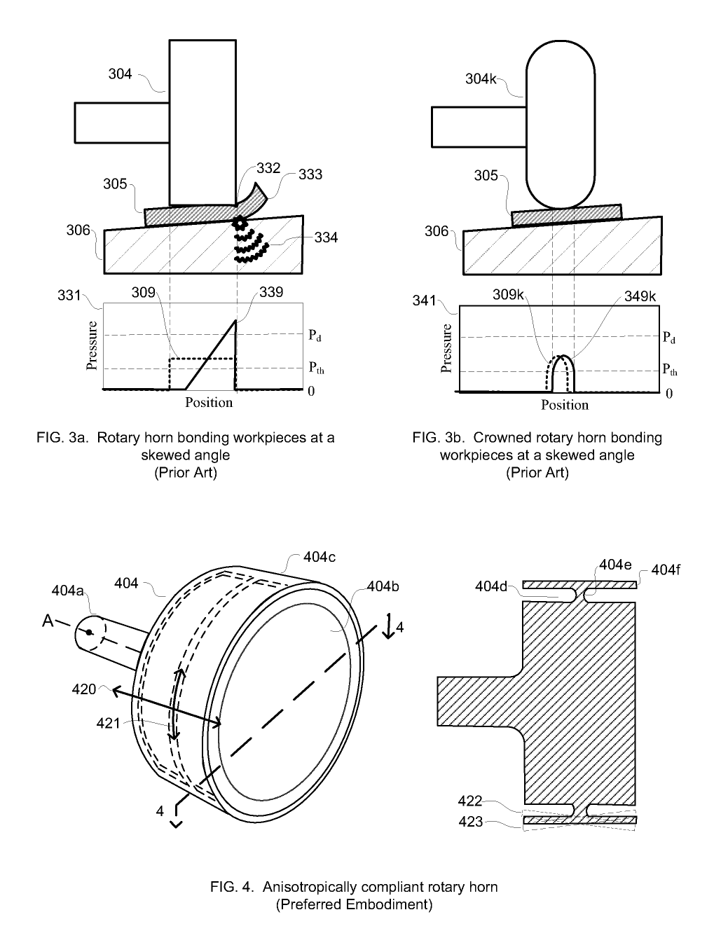

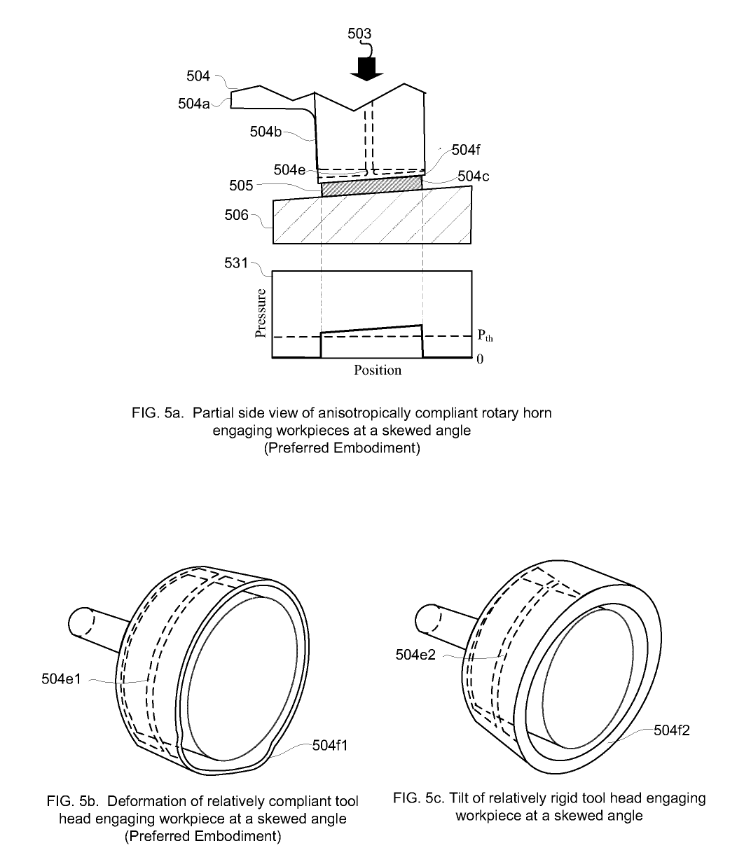

FIG. 5a shows the preferred-embodiment anisotropically compliant rotary horn 504 self-leveling as it contacts skew-angled workpieces 505 and 506, analogous to the workpieces in FIGS. 3a and 3b. Horn stem 504a and rigid tool body 504b remain at the angle (here, horizontal) at which horn stem 504a is held by the conventional horn mount (not shown). Tool neck 504e, however, flexes under the bonding pressure applied in direction 503 so that tool head 504f tilts at an angle parallel to the top surface of top workpiece 505, and toolface 504c makes full contact, with even pressure, across its entire width as shown in graph 531. Early experimental versions of this horn successfully self-leveled at initial engagement angles of >1°. In this embodiment, toolface 504c is slightly wider than foil 505, which automatically ensures that the edges of the foil are smoothly bonded even if the bonding process slightly widens the foil.

FIGS. 5b and 5c are perspective views of two embodiments of the rotary horn of FIG. 5a, showing how the tool head deformation depends on the relative compliance of the tool head and the tool neck. Where tool necks 504e1 of FIG. 5b and 504e2 of FIG. 5c are similarly compliant, the more compliant tool head 504f1 deforms locally under pressure against a skew-angled workpiece, whereas the more rigid tool head of alternate embodiment 504f2 tilts as a unit.

The cutouts that create the tool head and tool neck naturally affect the horn's resonant modes. Rotary horns in particular are sensitive to resonant-mode mismatches because they are integral parts of the ultrasonic resonant system, whereas spot-welding horns are usually relatively small, low-mass “tool tips” that have much less effect on the complete resonant system. Therefore, the cutouts need to be included in the resonance model when designing these anisotropically compliant horns. VSS bonding that can include surface-impurity removal involves ultrasonic vibrations that are substantially parallel to the bond-interface plane. If the vibration direction is defined by a straight line, a preferred dominant resonance mode for the anisotropically compliant rotary horn is a “piston” mode that oscillates parallel to the axis of rotation. If torsional vibrations are to be applied a preferred dominant resonance mode is centered on the axis of rotation.

Looking at the anisotropically compliant horn of FIGS. 4 and 5, those skilled in the art would probably expect the bonding efficiency to decrease under the more compliant parts of the toolface. The bonding pressure and vibration is communicated to the tool head and toolface through the flexure; therefore, either or both might be expected to be mitigated in the most compliant areas of the toolface. However, experiments show a much more uniform bond quality than the pressure differential might be expected to support.

Resonance modeling shows the reason for this unexpected result: the compliant areas support secondary vibration modes that contribute to the locally delivered bonding energy. Vibration modes perpendicular to the bond interface are not widely used for VSS bonding, although Joshi found that they worked well in some circumstances. Because of the added attraction of removing impurities from the bond interface, those skilled in the art use bond-interface-parallel vibration modes for VSS almost exclusively. While the horns of this invention are optimized to primarily resonate in bond-interface-parallel modes like prior-art VSS horns, the tool heads tend to develop localized secondary resonances, perpendicular to the bond interface, near their edges. The amplitude of these interface-perpendicular vibrations increases with distance from the tool neck. Because these modes can form a bond once the dominant bond-interface-parallel vibrations remove the impurities, they contribute to the ultrasonic energy delivered to the workpieces. Therefore, these modes, which are usually considered “unwanted,” actually help these horns to equalize the bonding energy (combined pressure and vibration) under those parts of the toolface that may deliver lower pressure because of their compliance when they flex to accommodate a skewed engagement angle. Experiments have shown that these horns can widen a foil under some circumstances, which is evidence of interface-perpendicular vibration. To prevent any ragged or rippled edges when bonding foil workpieces, the toolface can be made slightly wider than the foil to maintain full coverage even when the foil widens during bonding.

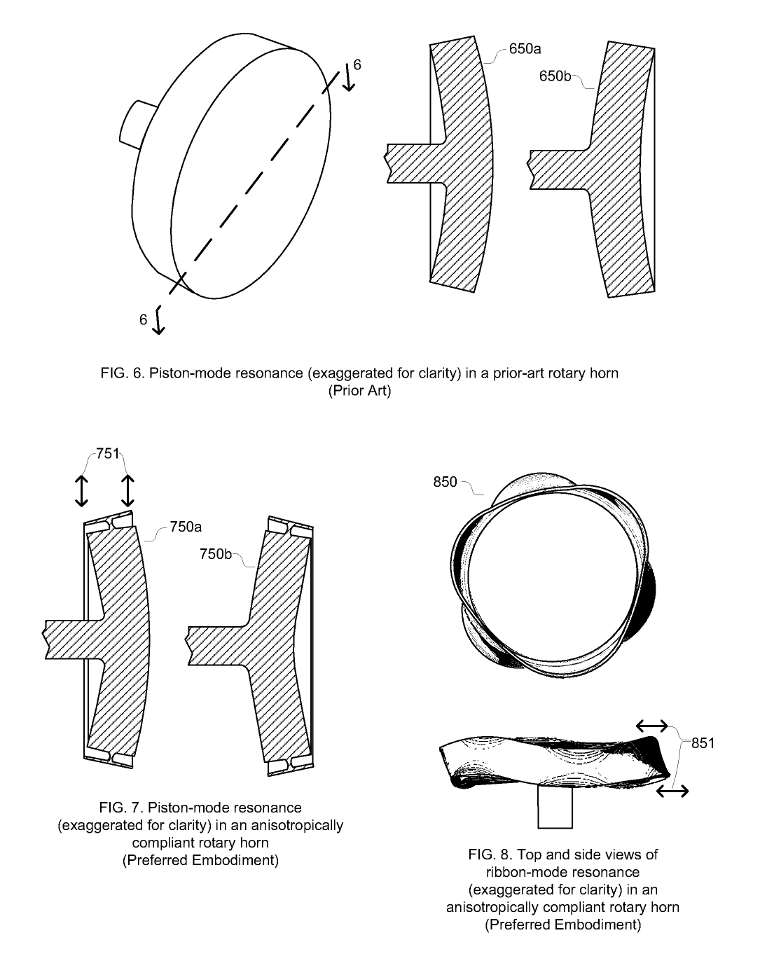

FIG. 6 is a perspective view of a prior-art solid rotary horn, with cross-sections through 6-6 showing (greatly exaggerated for clarity) the deformations of toolface 604c at the extrema 650a and 650b of a piston-mode resonance. This figure is included purely for comparison with FIG. 7.

FIG. 7 is a corresponding cross-section of an anisotropically compliant rotary horn of the preferred embodiment, showing the deformation at extrema 750a and 750b of a piston-mode resonance comparable to that in FIG. 6. The edges of the toolface on this horn draw in and flare out much more than the edges of the toolface on a solid horn, creating localized secondary modes of vibration 751. Vibration in this direction can contribute to VSS bonding according to Joshi, although it does not efficiently eject impurities from the bond interface. However, the primary mode of vibration across the toolface of the FIG. 7 horn is still in the impurity-removing orientation parallel to the bond interface. Experiments have shown that the dominant piston mode removes impurities, and the added bond-interface-perpendicular vibration at the edges of the toolface contributes to the bond energy at the edge regions. Similar excitation of localized secondary modes at the tool head edges have been observed in resonance models based on vibration acting torsionally about the circumference of the tool head (“ribbon” modes). Therefore, although conventional VSS wisdom would predict that the compliance of the edges would weaken the bonding in those areas, the experimental results show that the edges are strongly bonded because of their bond-interface-perpendicular vibration.

FIG. 8 shows top and side views of an extremum 850 of a three-lobed ribbon mode (exaggerated for clarity) in a preferred-embodiment rotary horn. As in the piston mode, the edges of the tool head are subject to localized secondary modes of vibration 851. Therefore, anisotropically compliant horns produce strong VSS bonds all the way to the edges of the bond interface, whether the driving signal is directed along a line or an arc.

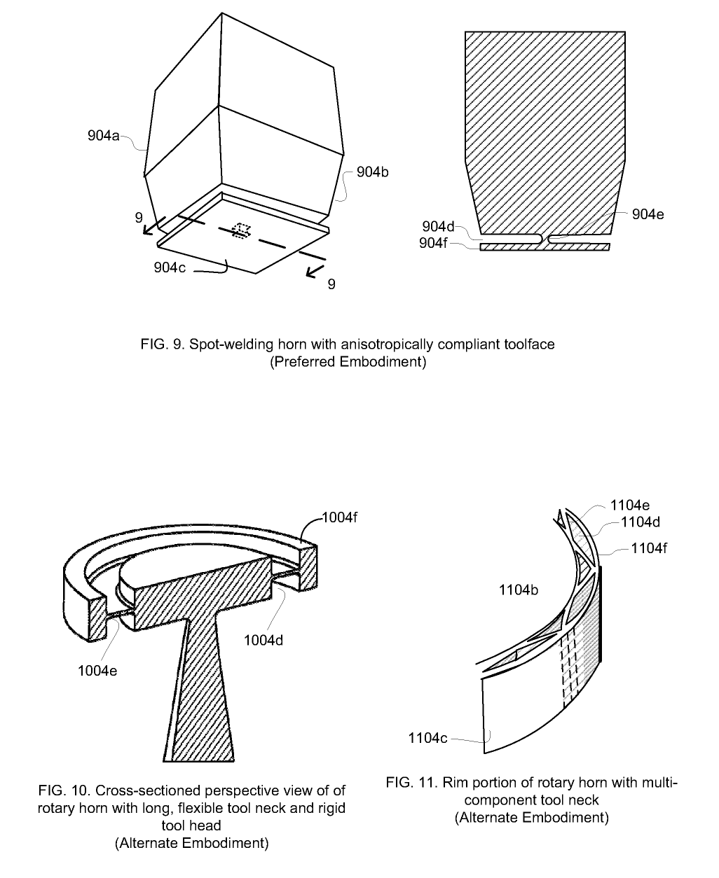

FIG. 9 shows an anisotropically compliant spot-welding horn according to the preferred embodiment. Cutouts 904d into the sides of tool body 904b leave a tool neck 904e extending substantially from the center of tool body 904b, and a relatively thin tool head 904f behind toolface 904c. Horn stem 904a can be configured to fit an existing VSS tool. Although the toolface illustrated has a square footprint and the horn stem has a square cross-section, those skilled in the art will understand that other shapes are possible within the scope of this invention.

The tool neck, as one would expect, is subject to repeated stress when it flexes under pressure to accommodate skewed workpiece engagement angles and excited with ultrasonic vibrations while in the flexed position. Experiments have shown that thickening the tool neck increases reliability and lengthens tool life; however, it decreases the range of angles over which the toolface can self-level. Therefore, a preferred design approach is to make the tool neck as thick as the required angle range will allow.

Model results also show that as the tool neck thickens, the localized secondary modes become weaker unless the tool head is made thinner to compensate. Because the tool head is subject to less stress and is a less likely point of mechanical failure, the tool head can usually be thinned substantially without decreasing reliability. Thus, a wide range of designs can be generated within the scope of this invention by choosing a horn material, a flexure shape, and a predetermined desired angle range, then thickening the tool neck to maximize reliability until any more thickening would begin to decrease the angle range, then thinning the tool head until the localized secondary modes of vibration at the edge of the toolface are as strong as necessary to produce a satisfactory bond at the edge of the bond interface. Compliance can be allocated between the tool head and tool neck for optimum resonant behavior, ease of manufacturing, power delivery to the workpieces, distribution of loading force on the workpieces, and extension of tool life. All the compliance may be in the neck, or in the head, or it can be distributed between both.

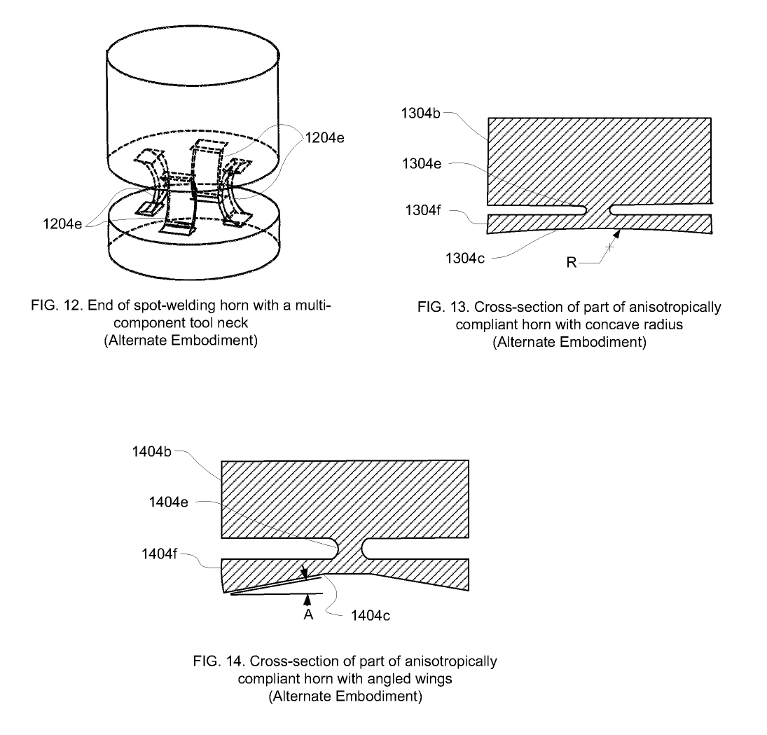

This invention includes alternate embodiments with different tool head and tool neck configurations. These configurations can modify the bond profile, control vibration damping, or adapt the compliant-horn VSS method for various workpiece-specific circumstances. FIG. 10 is a perspective view with cross-section of an embodiment of a rotary horn with a rigid tool head (i.e., the tool neck allows it to change angle, but it tilts as a unit as in FIG. 5c, rather than deforming locally as in FIG. 5b). Here, cutout 1004d that forms tool head 1004f and tool neck 1004e is wide, for compensating larger angles. FIG. 11 is a close-up perspective view of part of the rim of a rotary horn with a tool neck comprising multiple connecting members, in contrast to the single circumferential connecting member that forms the tool neck of FIG. 5. These multiple tool neck components 1104e are created by cutouts 1104d that are longitudinal through-holes (shown here as triangular, though the actual shape is arbitrary) in body 1104b, with a margin left intact as tool head 1104f behind toolface 1104c. FIG. 12 is a transparent perspective view of a spot-welding horn with a tool neck comprising multiple connecting members 1204e that can be fabricated by making a series of through-holes. Although the toolface illustrated has a circular footprint and the horn stem has a circular cross-section, those skilled in the art will understand that other shapes are possible within the scope of this invention.

Yet more alternate embodiments of this invention have concave toolface profiles that flatten under pressure. As the skewed engagement angle becomes larger, the “uphill” edge of the toolface will continue to contact the workpiece because of the applied pressure and the compliance of the tool neck, but the “downhill” edge may not receive enough restoring force from the flexure to maintain contact. The concave profile keeps the downhill edge of the horn in contact over a larger range, because the downhill side of the toolface substantially maintains its unpressurized shape.

FIG. 13 is a close-up cross-section showing part of tool body 1304b, along with tool neck 1304e, tool head 1304f, and toolface 1304c of an alternate embodiment. Toolface 1304c has a concave radius R when no pressure is applied, but the radius flattens to infinity when the horn is pressed against the workpieces at bonding pressure. A radius can be applied to either a rotary toolface (for example, a toroidal radius) or a spot-welding toolface (for example, a spherical radius).

FIG. 14 is a cross-section showing part of tool body 1404b, along with tool neck 1404e, tool head 1404f, and toolface 1404c of another alternate embodiment of a “faceted” concave toolface that flattens when bonding pressure is applied. Toolface 1404c is flat adjacent to tool neck 1404e, but slopes toward the workpiece at an angle A from the vicinity of the edge of tool neck 1404e to the edge of tool head 1404f. This type of concave toolface can also be adapted for a rotary horn or a spot-welding horn.

Those skilled in the art will recognize that toolface coatings or textures that are useful for VSS bonding with ordinary horns may also be used with the anisotropically compliant horns of this invention. Although the preferred embodiment is fabricated as a single piece, other embodiments may include compliant materials, such as elastomers, inserted in the horn cutouts between the tool head and the tool body to control the degree of compliance or to protect the tool neck from excessive instantaneous or repeated bending. Alternate embodiments may have at least one of the horn stem, tool body, tool neck, tool head, or toolface fabricated separately, out of the same material or a different material, and then attached to the other parts. However, because the re-application of pressure and ultrasonic energy re-softens bond interfaces, the attachment should either be by some method other than VSS bonding, or the bonding threshold of the horn materials must be considerably higher than that of the workpieces.

In summary, anisotropically compliant horns according to this invention allow the toolface to “self-level” when engaging workpieces at a skewed angle due to ordinary tolerances in thickness, flatness, and parallelism. Although the self-leveling may cause uneven pressure across the bond interface, the interface-perpendicular vibration modes that are strongest in the low-pressure areas equalize the total bond energy across the toolface, producing a uniform bond. Because these horns can successfully bond workpieces having these tolerances without being crowned and thus limiting the process to a smaller bond area, they increase the area of a VSS bond achievable on a single pass when the workpieces are delicate. Such large-area bonds are highly desirable when high mechanical strength or electrical integrity is required. These anisotropically compliant horns also self-level when engaging workpieces at skewed angles, so that tooling can be less complex, workpiece tolerances can be loosened and workpiece cost reduced. The anisotropically compliant horns produce uniform bonds across the toolface width even though the applied pressure decreases with distance from the tool neck, because the ultrasonic vibration amplitude increases with distance from the tool neck. These horns can be made compatible with existing VSS USW tools for either rotary welding or spot-welding, so their implementation is much less costly than alternatives requiring changes to the tool itself. The various alternative embodiments allow this invention to be customized for a wide variety of VSS requirements. Those skilled in the art will recognize that only the claims, not this description or the accompanying drawings, limit the scope of the invention.

The inventors claim:

1. An ultrasonic horn for vibratory solid-state ultrasonic welding of workpieces, comprising:
at least one horn stem configured for connection to a horn mount,
a tool body extending from the horn stem,
a tool neck extending from the tool body, a tool head connected to the tool neck opposite the tool body, and
a toolface on the tool head opposite the tool neck, where
at least one of the tool neck and the tool head is anisotropically compliant.

2. The horn of claim 1, where the tool neck is compliant and enables the toolface to flex under pressure.

3. The horn of claim 1, where the tool neck is compliant and enables the tool head to tilt under pressure.

4. The horn of claim 1, where the tool head is compliant and deforms locally under pressure

5. The horn of claim 1, where both the tool head and the tool neck are compliant.

6. The horn of claim 1, where the horn stem, tool body, tool neck, tool head, and toolface are fabricated from a single solid piece.

7. The horn of claim 1, where at least one of the horn stem, tool body, tool neck, tool head, and toolface are fabricated separately and attached together by a subsequent process.

8. The horn of claim 1, where the tool neck is a single connecting member between the tool body and the tool head.

9. The horn of claim 1, where the tool neck is a group of multiple connecting members between the tool body and the tool head.

10. The horn of claim 1, where the toolface overhangs an edge of at least one of the workpieces, sufficiently to smoothly bond the edge even if the workpiece expands during the bonding process.

11. The horn of claim 1, where the horn stem, tool body, toolface, tool neck, and tool head are configured for spot-welding.

12. The horn of claim 1, where the horn stem, tool body, toolface, tool neck, and tool head are configured for rotary welding.

13. The horn of claim 1, where the horn has been optimized to resonate with a driving signal at the operating ultrasonic frequency in a direction substantially parallel to a bond interface.

14. The horn of claim 1, where
a desired range of self-leveling angles is predetermined, and
the tool neck is as thick as possible while allowing the toolface to tilt throughout the desired range of self-leveling angles,

15. The horn of claim 14, where
a necessary strength of localized secondary modes of vibration is predetermined, and the tool head is thin enough to produce the necessary strength of localized secondary modes at edges of the toolface.

16. The horn of claim 1, further comprising compliant material inserted between the tool head and the tool body.

17. The horn of claim 16, where the compliant material is an elastomer.

18. The horn of claim 1, where the toolface has a concave surface that flattens when a bonding pressure is applied.

19. The horn of claim 18, where the toolface has a concave radius.

20. The horn of claim 18, where the concave surface is a plurality of facets.

21. A method of vibratory solid-state ultrasonic welding, comprising:
pressing a horn against a pair of workpieces to be bonded, and
ultrasonically vibrating the horn to form a bond, where
an anisotropically compliant toolface of the horn conforms to the workpieces over a range of engagement angles.

22. The method of claim 21, where
the horn ultrasonically vibrates substantially parallel to a bond interface between the two workpieces in a linear or torsional mode, and
the vibration of the horn removes surface impurities from the surfaces at the bond interface before forming the bond.

23. An article of manufacture, comprising a first workpiece and a second workpiece, where the first and second workpieces are bonded by vibratory solid-state ultrasonic welding over an area exceeding 6 square millimeters per bond despite engagement angles up to or exceeding 1 degree, by a horn with a toolface that flexes on a built-in tool neck to conform to the engagement angle of the workpieces.

24. The article of manufacture of claim 23, where at least one of the workpieces is coated with a thin film whose surface becomes part of the bond.

25. The article of manufacture of claim 24, where at least one of the workpieces is a foil.
